(19) United States
(12) Patent Application Publication
(10) Pub. No.: US 2026/0186303 A1
(43) Pub. Date: Jul. 2, 2026

(54) WAVEGUIDE FOR EYEWEAR DISPLAY HAVING AN EXPANDED FIELD OF VIEW AREA

(71) Applicant: GOOGLE LLC, Mountain View, CA (US)

(72) Inventors: Daniel Adema, Kitchener (CA); Shreyas Potnis, Kitchener (CA)

(21) Appl. No.: 18/863,853

(22) PCT Filed: May 9, 2023
(86) PCT No.: PCT/US2023/021488

§ 371 Date: Nov. 7, 2024

Related U.S. Application Data
(60) Provisional application No. 63/341,108, filed on May 12, 2022.

(51) Int. Cl. G02B 27/01; G06F 3/01; G09G 3/00

(52) U.S. Cl. CPC G02B 27/0172; G02B 27/0179; G06F 3/013; G09G 3/001; G02B 2027/0187; G09G 2354/00

(57) ABSTRACT

A waveguide includes a first set of optical components including a first incoupler, a first exit pupil expander, and a first outcoupler. The waveguide also includes a second set of optical components including a second incoupler, a second exit pupil expander, and a second outcoupler. The first outcoupler outcouples display light in a first section of a field of view (FOV) area and the second outcoupler outcouples display light in a second section of the FOV area different than the first section.

### BACKGROUND

In an augment reality (AR) or mixed reality (MR) eyewear display, light from an image source is coupled into a light guide substrate, generally referred to as a waveguide or a lightguide, by an input optical coupling (i.e., an “incoupler) which can be formed on a surface of the substrate or disposed within the substrate. Once the light beams have been coupled into the waveguide, the light beams are “guided” through the substrate, typically by multiple instances of total internal reflection (TIR), to then be directed out of the waveguide by an output optical coupling (i.e., an “outcoupler”). In some cases, another optical component known as an exit pupil expander is positioned in the optical path between the incoupler and the outcoupler to expand the light beams in at least one dimension. The light beams projected from the waveguide by the outcoupler overlap at an eye relief distance from the waveguide forming an exit pupil within which a virtual image generated by the image source can be viewed by the user of the eyewear display.

### SUMMARY

In a first embodiment, a waveguide includes a first set of optical components including a first incoupler, a first exit pupil expander, and a first outcoupler. The waveguide also includes a second set of optical components comprising a second incoupler, a second exit pupil expander, and a second outcoupler. The first outcoupler outcouples display light in a first section of a field of view (FOV) area and the second outcoupler outcouples display light in a second section of the FOV area different from the first section.

In some aspects of the first embodiment, the first section is arranged vertically adjacent to the second section in the FOV area. In some aspects of the first embodiment, the first section is horizontally adjacent to the second section in the FOV area. In some aspects of the first embodiment, the first incoupler and the second incoupler are located adjacent to one another on a same side of the waveguide. In some aspects of the first embodiment, the first incoupler and the second incoupler are located on opposite ends of the waveguide, wherein a first end is located in or near a temple region of an eyewear display housing the waveguide and a second end is located in or near a nose bridge region of the eyewear display. In some aspects of the first embodiment, the first incoupler and the second incoupler incouple light into the waveguide from a common image source. In some aspects of the first embodiment, the first incoupler incouples light from a first image source and the second incoupler incouples light into the waveguide from a second image source different than the first image source. In some aspects of the first embodiment, each of the first section and the second section of the FOV area correspond to a different user interface (UI) depth of an eyewear display. In some aspects of the first embodiment, the waveguide includes one or more additional sets of optical components, each of the one or more additional sets of optical components including a respective incoupler, exit pupil expander, and outcoupler, wherein each of the one or more additional sets of optical components corresponds to a distinct section of the FOV area.

In a second embodiment, an eyewear display includes one or more image sources to emit display light and a waveguide. The waveguide includes a plurality of sets of optical components, each set of the plurality of sets of optical components including a respective incoupler, exit pupil expander, and outcoupler, wherein each set outcouples display light received from the one or more image sources to a different section of a plurality of sections of a field of view (FOV) area of the eyewear display.

In some aspects of the second embodiment, a first incoupler of a first set of optical components of the plurality of sets of optical components incouples light from a first image source and a second incoupler of a second set of optical components of the plurality of sets of optical components incouples light from a second image source. In some aspects of the second embodiment light from the first image source and light from the second image source are combined to form a common image. In some aspects of the second embodiment, the first image source and the second image source are both in either a temple region or a nose bridge region of the eyewear display. In some aspects of the second embodiment, the first image source is in a temple region of the eyewear display and the second image source is in a nose bridge region of the eyewear display. In some aspects of the second embodiment, a first section of the plurality of sections is on top of a second section of the plurality of sections in the FOV area. In some aspects of the second embodiment, a first section of the plurality of sections is horizontally next to a second section of the plurality of sections in the FOV area. In some aspects of the second embodiment, a first section of the plurality of sections is a larger than a second section of the plurality of sections in the FOV area. In some aspects of the second embodiment, the eyewear display includes a plurality of image sources including the one or more image sources, and an eye tracking processing unit. The eye tracking processing unit tracks a user's gaze to a first section of the plurality of sections of the FOV area to determine which image source of the plurality of image sources to activate for emitting display light, wherein other ones of the plurality of image sources are deactivated in response to the one image source of the plurality of image sources being activated or the user's gaze being tracked to the first section.

In a third embodiment, an eyewear display includes a first image source located in a temple region of the eyewear display and a second image source located in a nose bridge region of the eyewear display. The eyewear display also includes a waveguide. The waveguide includes a first set of optical components including a first incoupler, a first exit pupil expander, and a first outcoupler, wherein the first incoupler is to incouple light from the first image source. The waveguide also includes a second set of optical components including a second incoupler, a second exit pupil expander, and a second outcoupler, wherein the second incoupler is to incouple light from the second image source. The first outcoupler outcouples light in a first section of a field of view (FOV) area of the eyewear display and the second outcoupler outcouples light in a second section of the FOV area.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example eyewear display, in accordance with some embodiments.

FIG. 2 shows an example diagram of a projection system that projects display light representing images onto the eye of a user via an eyewear display, such as the eyewear display of FIG. 1, in accordance with some embodiments.

FIG. 3 shows an example of light propagation within a waveguide of a projection system, such as the projection system of FIG. 2, in accordance with some embodiments.

FIG. 4 shows an example of a portion of an eyewear display with a limited field of view (FOV) area as identified in the present disclosure.

FIGS. 5 and 6 show issues of expanding the FOV area according to conventional techniques as identified in the present disclosure.

FIGS. 7-9 show examples of an eyewear display having a waveguide with multiple sets of optical components with each set of optical components being dedicated to a different section of a FOV area of the eyewear display, in accordance with some embodiments.

### DETAILED DESCRIPTION

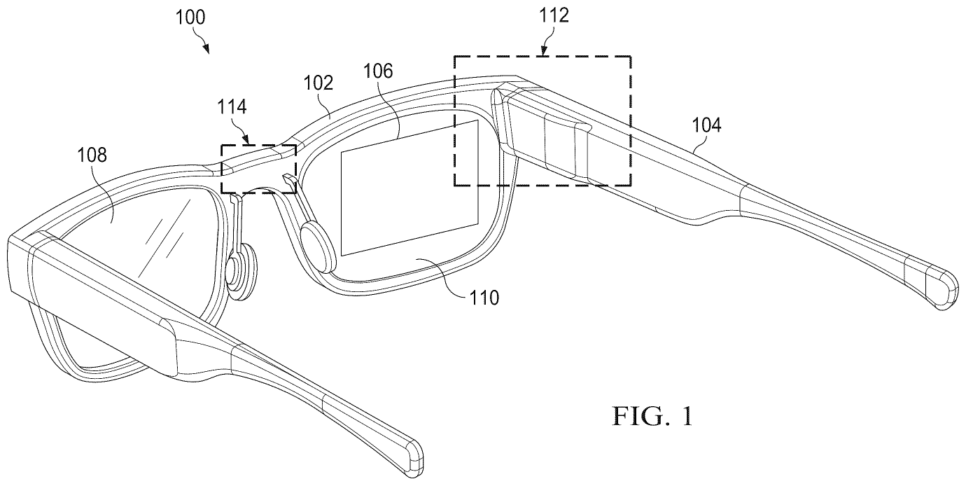

Lenses in an AR/MR eyewear display with an eyeglass frame form factor typically have a relatively small field of view (FOV) area for projecting images generated by the image source of the eyewear display. For example, in conventional eyewear displays of this type, the FOV area is normally on the scale of about 10° by 10° in the horizontal and vertical directions. In some cases, it may be advantageous to increase the size of the FOV area so the user is able to perceive images over a larger area of the lens of the eyewear display. Expanding the FOV area generally involves increasing the size of the outcoupler and the size of the corresponding exit pupil expander in the waveguide. However, due to the limited space available in the lens, increasing the size of both the exit pupil expander and the outcoupler in a waveguide using conventional techniques is not feasible since it would lead to significant interference (e.g., overlap) between the two. FIGS. 1-9 provide techniques to increase the FOV area in an eyewear display by splitting the FOV area into multiple sections. A waveguide in the lens of the eyewear display includes multiple sets of optical components. Each set of optical components includes an incoupler, exit pupil expander, and outcoupler being dedicated to one of the sections of the FOV area. Each set of optical components is located in the waveguide such that there is minimal or no overlap between the exit pupil expander and its corresponding outcoupler. By partitioning the FOV area into multiple sections and having a set of optical components dedicated to each section of the FOV area, the overall FOV area of an eyewear display is increased while overlap between the exit pupil expanders and outcoupler is minimized or eliminated altogether. Therefore, the eyewear display can display images over a larger area.

To illustrate, in some embodiments an eyewear display includes one or more image sources for emitting display light to form a virtual image to be perceived by a user of the eyewear display. The eyewear display also includes a waveguide at least partially integrated into a lens of the eyewear display. The waveguide includes a first set of optical components including a first incoupler, a first exit pupil expander, and a first outcoupler. The waveguide also includes a second set of optical components including a second incoupler, a second exit pupil expander, and a second outcoupler. The first set of optical components and the second set of optical components are located in different areas of the waveguide. The first set of optical components incouples display light emitted from the one or more image sources and outcouples it to a first section of a FOV area of the eyewear display. The second set of optical components incouples display light emitted from the one or more image sources and outcouples it to a second section of a FOV area of the eyewear display with the second section being adjacent (either horizontally or vertically) to the first section. In some embodiments, the first set of optical components incouples light from a first image source and the second set of optical components incouples light from a second image source. In certain scenarios, the first image source and the second image source are located in the same region of the eyewear display such as in a temple region or in a nose bridge region of the eyeglass frame. In other scenarios, the first image source is located in the temple region and the second image source is located in the nose bridge region of the eyeglass frame. In either case, the first outcoupler and the second outcoupler are arranged adjacent to one another in the waveguide to outcouple light in the adjacent sections of the FOV area. Accordingly, based on the sum of the areas covered by the first section and the second section, the overall FOV area is increased. This allows the user of the eyewear display to perceive images over a larger area of the lens of the eyewear display.

FIGS. 1-9 show devices and techniques for increasing the FOV area, thus increasing the virtual image display area, of an eyewear display as described in greater detail below. While the disclosed devices and techniques are described with respect to an example display system, it will be appreciated that present disclosure is not limited to implementation in this particular display system, but instead may be implemented in any of a variety of display systems using the guidelines provided herein.

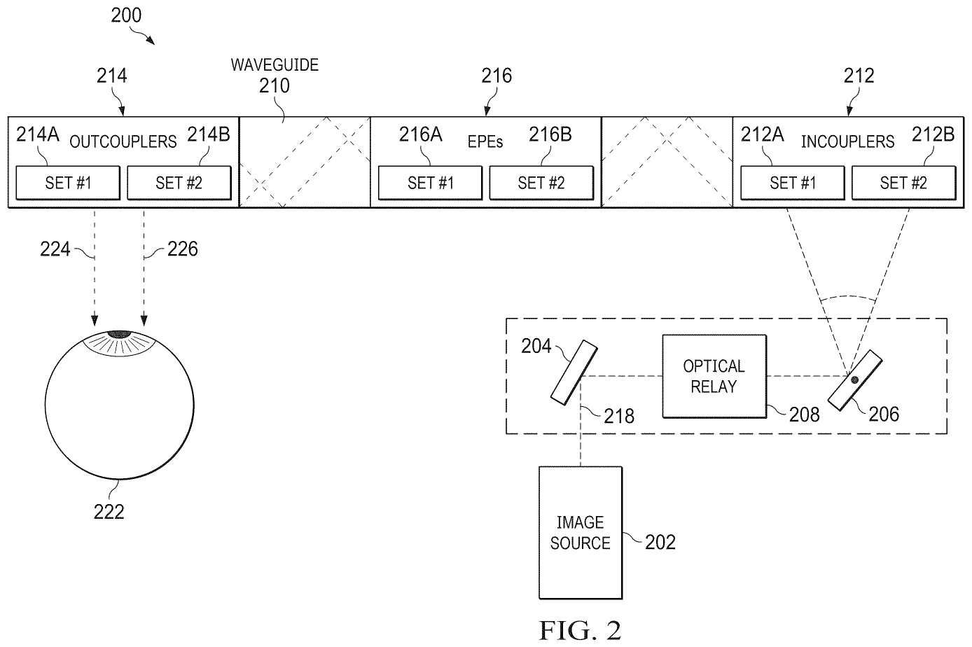

FIG. 1 illustrates an example eyewear display 100 in accordance with various embodiments. The eyewear display 100 (also referred to as a wearable heads up display (WHUD), head-mounted display (HMD), near-eye display, or the like) has a support structure 102 that includes an arm 104, which houses a micro-display projection system configured to project images toward the eye of a user, such that the user perceives the projected images as being displayed in a field of view (FOV) area 106 of a display at one or both of lens elements 108, 110. In the depicted embodiment, the support structure 102 of the eyewear display 100 is configured to be worn on the head of a user and has a general shape and appearance (i.e., “form factor”) of an eyeglasses frame. The support structure 102 contains or otherwise includes various components to facilitate the projection of such images toward the eye of the user, such as an image source (also referred to as light engine, optical engine, projector, or the like) and a waveguide (shown in FIG. 2, for example). In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. The support structure 102, in some embodiments, further includes processing circuitry or control circuitry to carry out functions of the eyewear display 100 such as eye tracking functions, for example. Further, in some embodiments, the support structure 102 includes one or more batteries or other portable power sources for supplying power to the electrical components of the eyewear display 100. In some embodiments, some or all of these components of the eyewear display 100 are fully or partially contained within an inner volume of support structure 102, such as within the arm 104 in a temple region 112 of the support structure 102 or in a nose bridge region 114 of the support structure 102. It should be noted that while an example form factor is depicted, it will be appreciated that in other embodiments the eyewear display 100 may have a different shape and appearance from the eyeglasses frame depicted in FIG. 1.

One or both of the lens elements 108, 110 are used by the eyewear display 100 to provide an AR or MR display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from an image source in the eyewear display 100. For example, light used to form a perceptible image or series of images may be projected by the image source of the eyewear display 100 onto the eye of the user via a series of optical elements, such as a waveguide formed at least partially in the corresponding lens element, one or more scan mirrors, one or more optical relays, and/or one or more prisms. In some embodiments, multiple image sources are included in the support structure 102. In some cases, the multiple image sources are located in the temple region 112, in the nose bridge region 114, or in a combination of the two regions (e.g., one image source in the temple region 112 and another image source in the nose bridge region 114). In some embodiments, the waveguide includes multiple sets of optical components where each set of optical components includes an incoupler, an exit pupil expander, and an outcoupler. Each incoupler is configured to incouple light from the one or more image sources and has a corresponding exit pupil expander and outcoupler for expanding light in at least one dimension and outcoupling light to a section of the FOV area 106, respectively. Accordingly, in some embodiments, the FOV area 106 includes multiple sections (not shown in FIG. 1) with each section having a set of optical components (i.e., an incoupler, an exit pupil expander, and an outcoupler) dedicated to it. One or both of the lens elements 108, 110 thus includes at least a portion of a waveguide that routes display light received by the multiple incouplers of the waveguide to the respective multiple outcouplers of the waveguide, which output the display light toward an eye of a user of the eyewear display 100. The display light is modulated and projected onto the eye of the user such that the user perceives the display light as an image in the FOV area 106. In addition, each of the lens elements 108, 110 is sufficiently transparent to allow a user to see through the lens elements to provide a field of view of the user's real-world environment such that the image appears superimposed over at least a portion of the real-world environment.

In some embodiments, each of the one or more image sources is a matrix-based projector, a scanning laser projector, or any combination of a modulative light source such as a laser or one or more LEDs and a dynamic reflector mechanism such as one or more dynamic scanners or digital light processors. In some embodiments, the image source includes multiple laser diodes (e.g., a red laser diode, a green laser diode, and/or a blue laser diode) and at least one scan mirror (e.g., two one-dimensional scan mirrors, which is a micro-electromechanical system (MEMS)-based or piezo-based), for example. The image source is communicatively coupled to a controller and a non-transitory processor-readable storage medium or memory storing processor-executable instructions and other data that, when executed by the controller, cause the controller to control the operation of the image source. In some embodiments, the controller controls a scan area size and scan area location for the image source and is communicatively coupled to a processor (not shown) that generates content to be displayed at the eyewear display 100. The image source scans light over a variable area, designated the FOV area 106, of the eyewear display 100. The scan area size corresponds to the size of the FOV area 106, and the scan area location corresponds to a region of one of the lens elements 108, 110 at which the FOV area 106 is visible to the user. Generally, it is desirable for a display to have a wide FOV area to accommodate the outcoupling of light across a wide range of angles. Herein, the range of different user eye positions that will be able to see the display is referred to as the eyebox of the eyewear display 100.

The techniques and apparatuses described herein increase the FOV area 106 of a waveguide within the form factor limitations imposed by the eyewear display 100. In some embodiments, a waveguide included in one or in each of lens elements 108, 110 includes two or more sets of optical components, where each set of optical components includes a respective incoupler, exit pupil expander, and outcoupler. The outcoupler of one set of optical components outcouples display light to a first section (e.g., a top or a left section) of the FOV area 106 and the outcoupler of each additional set of optical components outcouples display light to a different section (e.g., a bottom or a right section) of the FOV area 106. In this manner, the overall FOV area 106 is increased, thereby increasing the area in which images generated by the eyewear display 100 can be displayed to the user.

FIG. 2 illustrates a diagram of a projection system 200 that projects display light representing images onto the eye 222 of a user via a waveguide in an eyewear display, such as eyewear display 100 illustrated in FIG. 1. The projection system 200 includes an image source 202, an optical scanner 220, and a waveguide 210. One image source 202 and corresponding optical scanner 220 is illustrated in FIG. 2 for clarity purposes, but in some embodiments, multiple image sources 202 and optical scanners 220 are included in projection system 200.

In some embodiments, the image source 202 includes one or more laser light sources configured to generate and output laser light (e.g., visible laser light such as red, blue, and green laser light and/or non-visible laser light such as infrared laser light). In some embodiments, the image source 202 is coupled to a controller or driver (not shown), which controls the timing of emission of display light from the light sources of the image source 202 (e.g., in accordance with instructions received by the controller or driver from a computer processor coupled thereto) to modulate the display light 218 to be perceived as images when output to the retina of the eye 222 of the user.

In some embodiments, the optical scanner 220 includes a first scan mirror 204, a second scan mirror 206, and an optical relay 208. In some cases, one or both of the scan mirrors 204 and 206 are MEMS mirrors. For example, the scan mirror 204 and the scan mirror 206 are MEMS mirrors that are driven by respective actuation voltages to oscillate during active operation of the laser projection system 200, causing the scan mirrors 204 and 206 to scan the display light 218 toward an incoupler 212 of the waveguide 210.

The waveguide 210 of the projection system 200 includes multiple sets of optical components. Each set of optical components includes one of the incouplers 212, one of the exit pupil expanders (EPEs) 216, and one of the outcouplers 214. For example, in such embodiments, a first incoupler 212A is associated with a first exit pupil expander 216A and a first outcoupler 214A, a second incoupler 212B is associated with a second exit pupil expander 216B and a second outcoupler 214B, and so forth. The term “waveguide,” as used herein, will be understood to mean a combiner using total internal reflection (TIR), or via a combination of TIR, specialized filters, and/or reflective surfaces, to transfer light from an incoupler to a corresponding outcoupler. For display applications, the light is representative of a collimated image, for example, and the waveguide transfers and replicates the collimated image to the eye. In general, the terms “incoupler” and “outcoupler” will be understood to refer to any type of optical grating structure, including, but not limited to, diffraction gratings, slanted gratings, blazed gratings, holograms, holographic optical elements (e.g., optical elements using one or more holograms), volume diffraction gratings, volume holograms, surface relief diffraction gratings, and/or surface relief holograms. In some embodiments, the incoupler includes one or more facets or reflective surfaces. In some embodiments, a given incoupler, EPE, or outcoupler is configured as a transmissive diffraction grating that causes the incoupler, EPE, or outcoupler to transmit light and to apply designed optical function(s) to the light during the transmission. In some embodiments, a given incoupler, EPE, or outcoupler is a reflective diffraction grating that causes the incoupler, EPE, or outcoupler to reflect light and to apply designed optical function(s) to the light during the reflection. In the present example, the display light 218 received at the incouplers 212 is relayed through the EPEs 216 to the outcouplers 214 via the waveguide 210 using TIR. The display light is then output to the eye 222 of a user via the outcouplers 214 as light 224 and 226.

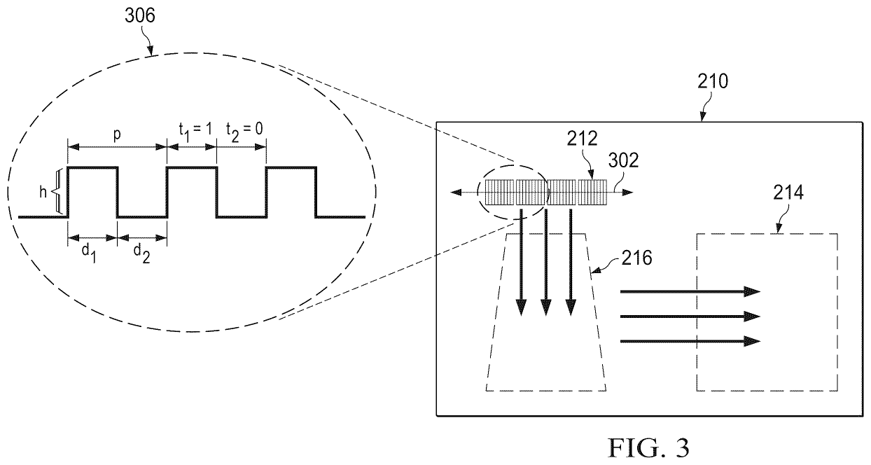

In some embodiments, the waveguide 210 includes multiple sets of optical components with each set of optical components having a corresponding incoupler (one of the incouplers 212A and 212B), a corresponding exit pupil expander (one of EPEs 216A and 216B), and a corresponding outcoupler (one of the outcouplers 214A and 214B). For example, a first set (SET #1) includes incoupler 212A, EPE 216A, and outcoupler 214A, and a second set (SET #2) includes incoupler 212B, EPE 216B, and outcoupler 214B. One such set of optical components is illustrated and described in FIG. 3. In some embodiments, each set of optical components receives display light 218 from a common or shared image source 202. In other embodiments, each set of optical components receives display light 218 from a different image source 202, i.e., there are multiple image sources 202 in the projection system 200 with each image source 202 being dedicated to emitting light to one of the multiple incouplers 212 in the waveguide 210. Each set of optical components in the waveguide 210 is dedicated to receive display light from the one or more image sources 202 and outcouple it to a different section of a FOV area, such as FOV area 106 in FIG. 1. For example, in FIG. 2, a first outcoupler 214A outcouples display light 224 and a second outcoupler 214B outcouples display light 226. Each one of the outcoupled display light beams 224 and 226 is outcoupled at a different section of an FOV area of a lens element including the waveguide 210. Accordingly, the FOV area of a single waveguide such as waveguide 210 can be increased so that the user of an eyewear display is able to see images generated from the image source 202 over a larger display area.

FIG. 3 shows an example of light propagation within one set of optical components of the waveguide 210 of the projection system 200 of FIG. 2. As shown, light is received via an incoupler 212, directed into an EPE 216, and then routed to the outcoupler 214 to be output from the waveguide 210 (e.g., toward the eye of the user). In some embodiments, the EPE 216 expands one or more dimensions of the eyebox of an eyewear display that includes the projection system 200 (e.g., with respect to what the dimensions of the eyebox of the eyewear display would be without the EPE 216). In some embodiments, the incoupler 212 and the EPE 216 each include respective one-dimensional diffraction gratings (i.e., diffraction gratings that extend along one dimension). It should be understood that FIG. 3 shows a case in which incoupler 212 directs light straight down (with respect to the presently illustrated view) in a first direction that is perpendicular to the scanning axis 302, and the EPE 216 directs light to the right (with respect to the presently illustrated view) in a second direction that is perpendicular to the first direction. While not shown in the present example, it should be understood that, in some embodiments, the first direction in which the incoupler 212 directs light is slightly or substantially diagonal, rather than exactly perpendicular, with respect to the scanning axis 302.

In some embodiments, the waveguide 210 includes multiple sets of optical components with each set of optical components including a corresponding incoupler 212, a corresponding EPE 216, and a corresponding outcoupler 214. In such embodiments, a first incoupler 212 (such as incoupler 212A in FIG. 2) corresponds to a first EPE 216 (such as EPE 216A in FIG. 2) and a first outcoupler 214 (such as outcoupler 214A in FIG. 2), and a second incoupler 212 (such as incoupler 212B in FIG. 2) corresponds with a second EPE 216 (such as EPE 216B in FIG. 2) and a second outcoupler 214 (such as outcoupler 214B in FIG. 2). In this manner, each corresponding set of one incoupler, one EPE, and one outcoupler is referred to as a “set of optical components” (also referred to as “reflective facet set” in some cases). In some embodiments, each set of optical components outcouples light to a different section of the FOV area (such as FOV area 106) provided by an eyewear display (such as eyewear display 100). Accordingly, each set of optical components includes one outcoupler dedicated to one of the different sections of the FOV area. In some embodiments, the incouplers 212 are located on the same side (e.g., close to or in the temple region of an eyewear display or close to or in the nose bridge region of an eyewear display) of the waveguide 212. In other embodiments, the incouplers 212 are located on different sides (e.g., one close to or in the temple region and another incoupler close to or in the nose bridge region) of the waveguide 212.

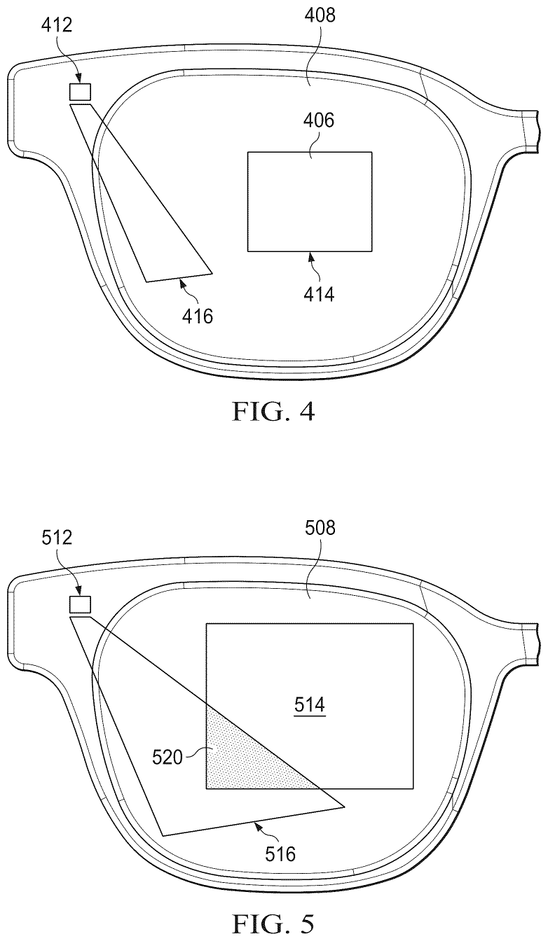

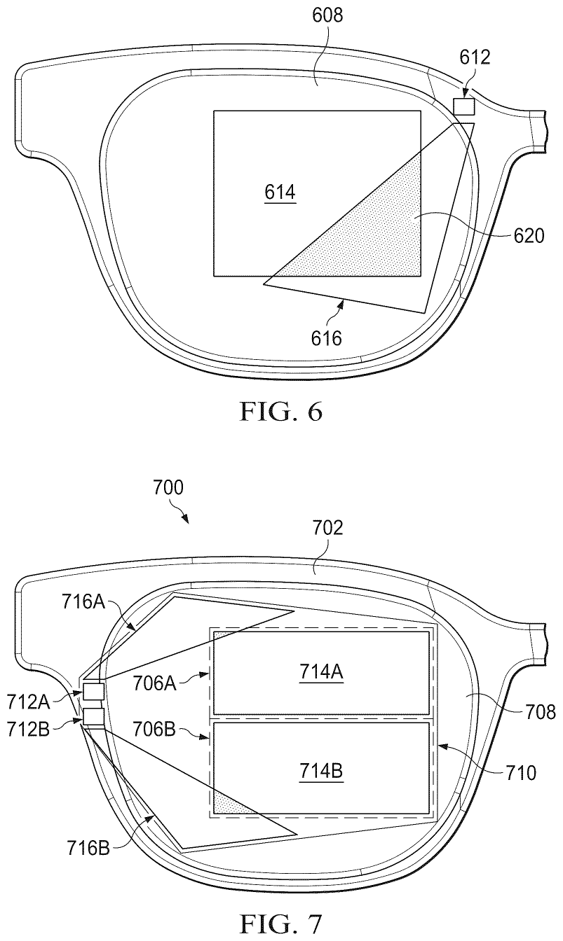

FIG. 4 shows an example of a portion of an eyewear display 400 having an eyeglass frame form factor with a limited FOV 406 as identified in accordance with some embodiments. For example, the FOV 406 is in the range of about 10°×10° in the horizontal and vertical directions since there is limited space available in lens 408 to incorporate a conventional waveguide. As illustrated in FIG. 4, the components of the waveguide include an incoupler 412, an outcoupler 414, and an exit pupil expander 416. In FIG. 4, the incoupler 412 is located in the temple region of the support structure of the eyewear display 400. The exit pupil expander 416 is located partially in the temple region and partially in the lens 408 while the outcoupler 414 is located entirely in the lens 408 and corresponds to the FOV area 406. Thus, increasing the FOV area 406 involves increasing the size of the outcoupler 414, which also requires expanding the size of the exit pupil expander 416. However, due to the limited space available in the lens 408, increasing the sizes of the outcoupler 414 and the exit pupil expander 416 according to conventional techniques is generally not possible due to the issues illustrated in FIGS. 5 and 6.

FIGS. 5 and 6 illustrate issues when expanding the FOV area according to conventional techniques. FIG. 5 shows an example where the incoupler 512 is located in the temple region of the support structure. FIG. 6 shows an example where the incoupler 612 is located in the nose bridge region of the support structure. In either case, a larger outcoupler (outcoupler 514 and outcoupler 614 in FIGS. 5 and 6, respectively) and a larger exit pupil expander (exit pupil expander 516 and exit pupil expander 616 in FIGS. 5 and 6, respectively) are needed to provide a larger FOV area. However, increasing the sizes of the outcoupler and exit pupil expander leads to significant overlap 520 and 620 between the two as shown in FIGS. 5 and 6, respectively. These overlaps 520 and 620 lead to conflict between the exit pupil expander (i.e., expanding the display light in a first dimension) and the outcoupler (i.e., expanding the display light in a second dimension different from the first dimension) that cannot be resolved by trimming at least one of the exit pupil expander or the outcoupler without severely impacting the quality of the image delivered to the user. Thus, conventional techniques to increase the FOV area of a waveguide are severely limited by the form factor of the lens and/or the eyeglass frame in this type of eyeglass display.

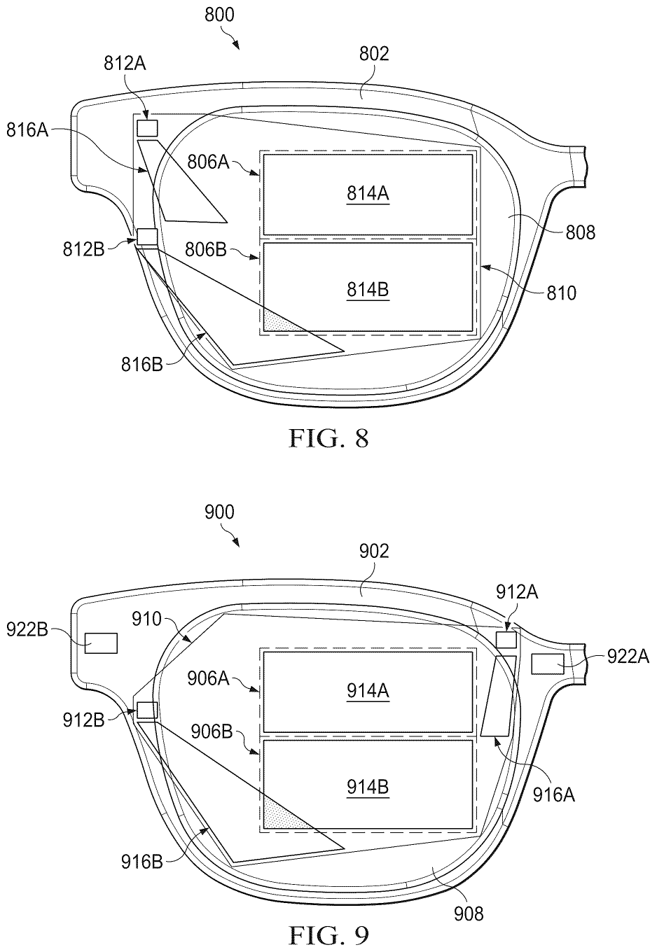

FIG. 7 shows an example of a portion of an eyewear display 700 according to some embodiments. The eyewear display 700 shown in FIG. 7 includes part of a support structure 702 (i.e., an eyeglass frame) and one lens 708. A waveguide 710 is integrated into the lens 708 and part of the support structure 702 and includes two sets of optical components. The first set of the two sets of optical components includes first incoupler 712A, first exit pupil expander 716A, and first outcoupler 714A. The second set of the two sets of optical components includes second incoupler 712B, second exit pupil expander 716B, and second outcoupler 714B. In the embodiment shown in FIG. 7, the incouplers 712A and 712B are located closely to one another in the temple region of the eyewear display 700. That is, the incouplers 712A and 712B are located on the same side of the waveguide 710 (i.e., left side of the waveguide 710 in or near the temple region).

Incoupler 712A receives display light from an image source (not shown) and incouples the light into the waveguide 710 toward the exit pupil expander 716A. The exit pupil expander 716A expands the light in one dimension (e.g., dimension corresponding to a vertical direction in FIG. 7) and transmits the light toward outcoupler 714A. Outcoupler 714A expands the light in another dimension (e.g., dimension corresponding into the page in FIG. 7) and outcouples the display light to the user over a first section 706A of the FOV area. Incoupler 712B receives display light from an image source (not shown) and incouples the light into the waveguide 710 toward the exit pupil expander 716B. The exit pupil expander 716B expands the light in one dimension (e.g., dimension corresponding to a vertical direction in FIG. 7) and transmits the light toward outcoupler 714B. Outcoupler 714B expands the light in another dimension (e.g., dimension corresponding into the page in FIG. 7) and outcouples the display light to the user over a second section 706B of the FOV area. In some embodiments, incouplers 712A and 712B receive display light from a common (i.e., the same) image source. In this scenario, the display light from the image source is directed to each of incoupler 712A and 712B by MEMS mirrors (as illustrated in FIG. 2) or by a prism (not shown). In other embodiments, each of incouplers 712A and 712B receive the display light from a different image source. In either case, the first set of optical components 712A, 716A, 714A is dedicated to a first section 706A of the FOV area and the second set of optical components 712B, 716B, 714B is dedicated to a second section 706B of the FOV area, where the FOV area is the sum of the first section 706A and the second section 706B.

By splitting the FOV area into multiple sections 706A, 706B with each section having its dedicated set of optical components, the overall FOV area associated with a waveguide 710 (i.e., a common or single waveguide substrate) in the eyewear display 700 is increased while the interference (e.g., overlap) between the optical components is minimized or eliminated as compared with the conventional techniques shown in FIGS. 5 and 6. In some embodiments, at least one of the exit pupil expander and/or the outcoupler is trimmed to eliminate any remaining overlap between the optical components in the waveguide. Thus, by implementing the techniques shown in FIG. 7, the overall FOV area of the eyewear display 700 is increased, thereby increasing the area of the lens 708 in which the user is able to view images generated by the eyewear display 700.

FIG. 8 shows an example of a portion of an eyewear display 800 according to some embodiments. The eyewear display 800 shown in FIG. 8 includes part of a support structure 802 (i.e., an eyeglass frame) and one lens 808. A waveguide 810 is integrated into the lens 808 and part of the support structure 802 and includes two sets of optical components. The first set of the two sets of optical components includes first incoupler 812A, first exit pupil expander 816A, and first outcoupler 814A. The second set of the two sets of optical components includes second incoupler 812B, second exit pupil expander 816B, and second outcoupler 814B. The incouplers 812A and 812B are located on a same side of the waveguide 810 (i.e., left side of the waveguide 810 in or near the temple region). However, in the embodiment shown in FIG. 8, the incouplers 812A and 812B are located farther apart from one another in the temple region compared to the embodiment shown in FIG. 7. In some cases, this may be advantageous (depending on the form factor of the lens and/or eyeglass frame) to further reduce any potential overlap between the optical components in the waveguide 810. For example, as shown in FIG. 8, there is no overlap between exit pupil expander 816A and outcoupler 814A.

Incoupler 812A receives display light from an image source (not shown) and incouples the light into the waveguide 810 toward the exit pupil expander 816A. The exit pupil expander 816A expands the light in one dimension (e.g., dimension corresponding to a vertical direction in FIG. 8) and transmits the light toward outcoupler 814A. Outcoupler 814A expands the light in another dimension (e.g., dimension corresponding into the page in FIG. 8) and outcouples the display light to the user over the first section 806A of the FOV area. Incoupler 812B receives display light from an image source (not shown) and incouples the light into the waveguide 810 toward the exit pupil expander 816B. The exit pupil expander 816B expands the light in one dimension (e.g., dimension corresponding to a vertical direction in FIG. 8) and transmits the light toward outcoupler 814B. Outcoupler 814B expands the light in another dimension (e.g., dimension corresponding into the page in FIG. 8) and outcouples the display light to the user over a second section 806B of the FOV area. In some embodiments, incouplers 812A and 812B receive display light from a common (i.e., the same) image source. In this scenario, the display light from the image source is directed to each of incoupler 812A and 812B by MEMS mirrors (as illustrated in FIG. 2) or by a prism (not shown). In other embodiments, each of incouplers 812A and 812B receive the display light from a different image source. In either case, the first set of optical components 812A, 816A, 814A is dedicated to a first section 806A of the FOV area and the second set of optical components 812B, 816B, 814B is dedicated to a second section 806B of the FOV area, where the FOV area is the sum of the first section 806A and the second section 806B.

By splitting the FOV area into multiple sections 806A, 806B with each section having its dedicated set of optical components, the overall FOV area associated with a waveguide 810 (i.e., a common or single waveguide substrate) in the eyewear display 800 is increased while the interference (e.g., overlap) between the optical components is minimized or eliminated as compared with the conventional techniques shown in FIGS. 5 and 6. In some embodiments, at least one of the exit pupil expander and/or the outcoupler is trimmed to eliminate any remaining overlap between the optical components in the waveguide. Thus, by implementing the techniques shown in FIG. 8, the overall FOV area of the eyewear display 800 is increased, thereby increasing the area of the lens 808 in which the user is able to view images generated by the eyewear display 800.

FIG. 9 shows an example of a portion of an eyewear display 900 according to some embodiments. The eyewear display 900 shown in FIG. 9 includes part of a support structure 902 (i.e., an eyeglass frame) and one lens 908. A waveguide 910 is integrated into the lens 908 and part of the support structure 902 and includes two sets of optical components. The first set of the two sets of optical components includes first incoupler 912A, first exit pupil expander 916A, and first outcoupler 914A. The second set of the two sets of optical components includes second incoupler 912B, second exit pupil expander 916B, and second outcoupler 914B. In the embodiment shown in FIG. 9, the incouplers 912A and 912B are located on opposite sides of the waveguide 910. That is, incoupler 912A is located in or near the nose bridge region of the eyewear display 900 and incoupler 912B is located in or near the temple region of eyewear display 900. In some cases, this may be advantageous (depending on the form factor of the lens and/or eyeglass frame) to further reduce any potential overlap between the optical components in the waveguide 910 while increasing the size of the FOV area of the eyewear display 900.

Incoupler 912A receives display light from a first image source 922A and incouples the light into the waveguide 910 toward the exit pupil expander 916A. The exit pupil expander 916A expands the light in one dimension (e.g., dimension corresponding to a vertical direction in FIG. 7) and transmits the light toward outcoupler 914A. Outcoupler 914A expands the light in another dimension (e.g., dimension corresponding into the page in FIG. 9) and outcouples the display light to the user over a first section 906A of the FOV area. Incoupler 912B receives display light from a second image source 922B and incouples the light into the waveguide 910 toward the exit pupil expander 916B. The exit pupil expander 916B expands the light in one dimension (e.g., dimension corresponding to a vertical direction in FIG. 9) and transmits the light toward outcoupler 914B. Outcoupler 914B expands the light in another dimension (e.g., dimension corresponding into the page in FIG. 9) and outcouples the display light to the user over a second section 906B of the FOV area. In the embodiment shown in FIG. 9, each of incouplers 912A and 912B receive the display light from a different image source. For example, the first image source 922A emitting display light to incoupler 912A is located in the nose bridge area of the eyeglass display 900 and the second image source 922B emitting display light to incoupler 912B is located in the temple region of the eyeglass display 900. The first set of optical components 912A, 916A, 914A is dedicated to a first section 906A of the FOV area and the second set of optical components 912B, 916B, 914B is dedicated to a second section 906B of the FOV area, where the FOV area is the sum of the first section 906A and the second section 906B.

By splitting the FOV area into multiple sections 906A, 906B with each section having its dedicated set of optical components, the overall FOV area associated with a waveguide 910 (i.e., a common or single waveguide substrate) in the eyewear display 900 is increased while the interference (e.g., overlap) between the optical components is minimized or eliminated as compared with the conventional techniques shown in FIGS. 5 and 6. In some embodiments, at least one of the exit pupil expander and/or the outcoupler is trimmed to eliminate any remaining overlap between the optical components in the waveguide. Thus, by implementing the techniques shown in FIG. 9, the overall FOV area of the eyewear display 900 is increased, thereby increasing the area of the lens 908 in which the user is able to view images generated by the eyewear display 900.

In some embodiments, the different sections of the FOV area illustrated in FIGS. 7-9 may be arranged adjacent to each other horizontally rather than vertically as shown in FIGS. 7-9. For example, in such a scenario, referring to FIG. 9, the first set of optical components 912A, 914A, and 916A is dedicated to a FOV area that is on the right side of the overall FOV area (rather than on top as shown in FIG. 9) and the second set of optical components 912B, 914B, and 916B is dedicated to a FOV area that is on the left side of the overall FOV area (rather than on the bottom as shown in FIG. 9). In some embodiments, although shown as being similar in size in FIGS. 7-9, the different sections of the FOV area are different sizes. For example, referring to FIG. 8, the top section (i.e., first section 806A) of the FOV area can be smaller than the bottom section (i.e., second section 806B) of the FOV area.

In FIGS. 7-9, the illustrated examples show the eyewear display having a FOV area that is split into two sections. It is appreciated that this is for clarity purposes and in some embodiments, this number is scalable to other amounts. For example, in some embodiments, the FOV area can be split into four sections (i.e., quadrants) each having its own set of dedicated optical components. In such a scenario, for example, two incouplers can be positioned at or near the temple region and the other two incouplers can be positioned at or near the nose bridge region. Each of the four outcouplers can thus be positioned at a top-left, top-right, bottom-left, and bottom-right section of the FOV area with the corresponding exit pupil expanders positioned between the respective incoupler and outcoupler pairing.

In some embodiments, the images displayed at each of the different sections of the FOV areas shown in FIGS. 7-9 are stitched together to form a common, continuous image. In this scenario, a controller or processor of the eyewear display controls the one or more image sources to emit light according to the common image to be displayed over the overall FOA area including the different sections of the FOV area. In other embodiments, the images displayed at each of the different sections are distinct from one another. For example, one section of the FOV area may have a different user interface (UI) depth than the other (e.g., the top section of the FOV area may be focused at a farther distance and the bottom section of the FOV area may be focused at a closer distance). In the cases including multiple image sources, the multiple image sources, in some embodiments, have different colors or different polarizations from one another to minimize crosstalk between the projection systems.

In some embodiments, the eyewear display includes an eye tracking system including one or more processors to detect which section the user's eye is focused on (e.g., referring to FIG. 7, if the user's eye is focused on first section 706A or on second section 706B) and activate the image source associated with that particular section of the FOV area. In some embodiments, the other ones of the image sources are deactivated in response to the one image source being activated or the user's gaze being tracked to the particular section. In some embodiments, the deactivation of the other image sources conserves the power resources (i.e., extends the battery life) of the eyewear display.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A waveguide comprising:
a first set of optical components comprising a first incoupler, a first exit pupil expander, and a first outcoupler; and
a second set of optical components comprising a second incoupler, a second exit pupil expander, and a second outcoupler,
wherein the first outcoupler outcouples display light in a first section of a field of view (FOV) area and the second outcoupler outcouples display light in a second section of the FOV area different from the first section.

2. The waveguide of claim 1, wherein the first section is arranged vertically adjacent to the second section in the FOV area.

3. The waveguide of claim 1, wherein the first section is horizontally adjacent to the second section in the FOV area.

4. The waveguide of claim 1, wherein the first incoupler and the second incoupler are located adjacent to one another on a same side of the waveguide.

5. The waveguide of claim 1, wherein the first incoupler and the second incoupler are located on opposite ends of the waveguide, wherein a first end is located in or near a temple region of an eyewear display housing the waveguide and a second end is located in or near a nose bridge region of the eyewear display.

6. The waveguide of claim 1, wherein the first incoupler and the second incoupler incouple light into the waveguide from a common image source.

7. The waveguide of claim 1, wherein the first incoupler incouples light from a first image source and the second incoupler incouples light into the waveguide from a second image source different than the first image source.

8. The waveguide of claim 1, wherein each of the first section and the second section of the FOV area correspond to a different focal range of an eyewear display.

9. The waveguide of claim 1, wherein each of the first section and the second section of the FOV area correspond to a different user interface (UI) depth of an eyewear display.

10. The waveguide of claim 1, further comprising one or more additional sets of optical components, each of the one or more additional sets of optical components comprising a respective incoupler, exit pupil expander, and outcoupler, wherein each of the one or more additional sets of optical components corresponds to a distinct section of the FOV area.

11. An eyewear display comprising:
one or more image sources to emit display light; and
a waveguide comprising:
a plurality of sets of optical components, each set of the plurality of sets of optical components comprising a respective incoupler, exit pupil expander, and outcoupler, wherein each set outcouples display light received from the one or more image sources to a different section of a plurality of sections of a field of view (FOV) area of the eyewear display.

12. The eyewear display of claim 11, wherein a first incoupler of a first set of optical components of the plurality of sets of optical components incouples light from a first image source and a second incoupler of a second set of optical components of the plurality of sets of optical components incouples light from a second image source.

13. The eyewear display of claim 12, wherein light from the first image source and light from the second image source are combined to form a common image.

14. The eyewear display of claim 12, wherein the first image source and the second image source are both in either a temple region or a nose bridge region of the eyewear display.

15. The eyewear display of claim 12, wherein the first image source is in a temple region of the eyewear display and the second image source is in a nose bridge region of the eyewear display.

16. The eyewear display of claim 11, wherein a first section of the plurality of sections is on top of a second section of the plurality of sections in the FOV area.

17. The eyewear display of claim 11, wherein a first section of the plurality of sections is horizontally next to a second section of the plurality of sections in the FOV area.

18. The eyewear display of claim 11, wherein a first section of the plurality of sections is a larger than a second section of the plurality of sections in the FOV area.

19. The eyewear display of claim 11, further comprising:
a plurality of image sources comprising the one or more image sources; and
an eye tracking processing unit to track a user's gaze to a first section of the plurality of sections of the FOV area to determine which image source of the plurality of image sources to activate for emitting display light, wherein other ones of the plurality of image sources are deactivated in response to the one image source of the plurality of image sources being activated or the user's gaze being tracked to the first section.

20. An eyewear display comprising:
a first image source located in a temple region of the eyewear display and a second image source located in a nose bridge region of the eyewear display; and
a waveguide comprising:
a first set of optical components comprising a first incoupler, a first exit pupil expander, and a first outcoupler, wherein the first incoupler is to incouple light from the first image source; and
a second set of optical components comprising a second incoupler, a second exit pupil expander, and a second outcoupler, wherein the second incoupler is to incouple light from the second image source,
wherein the first outcoupler is configured to outcouple light in a first section of a field of view (FOV) area of the eyewear display and the second outcoupler is configured to outcouple light in a second section of the FOV area.
